(19) United States
(12) Patent Application Publication
(10) Pub. No.: US 2010/0053117 A1
(43) Pub. Date: Mar. 4, 2010

(54) WRITING DEVICE

(75) Inventors: Tsutomu ISHII, Ebina-shi (JP); Yasunori SAITO, Ashigarakami-gun (JP); Shigehiko SASAKI, Ebina-shi (JP); Akira ICHIBOSHI, Ebina-shi (JP); Masahiro SATO, Ebina-shi (JP); Kyotaro TOMODA, Ebina-shi (JP)

Correspondence Address: OLIFF & BERRIDGE, PLC, P.O. BOX 320850, ALEXANDRIA, VA, 22320-4850, US

(73) Assignee: Fuji Xerox Co., LTD., Tokyo (JP)

(21) Appl. No.: 12/364,896

(22) Filed: Feb. 3, 2009

(30) Foreign Application Priority Data
Aug. 26, 2008 (JP) 2008-216876

(51) Int. Cl. G06F 3/042

(52) U.S. Cl. 345/175

(57) ABSTRACT

A writing device comprising: an irradiation unit that irradiates light to an optically writable display medium which displays an image responsive to irradiated light; a focusing unit that focuses light irradiated by the irradiation unit on the display medium; and a selector that causes the light irradiated by the irradiation unit to pass through or not to pass through the focusing unit for irradiation to the display medium.

### CROSS-REFERENCE TO RELATED APPLICATIONS

This application is based on and claims priority under 35 U.S.C. 119 from Japanese Patent Application No. 2008-216876, which was filed on Aug. 26, 2008.

### BACKGROUND

1. Technical Field

The present invention relates to a writing device.

2. Related Art

There is a writing device in which information is written by irradiating light to a display of the type used for optical writing. The display of the type used for optical writing is a display having a display element that performs display in accordance with the irradiated light, and is hereinafter referred to as an “optical writing type display”. The optical writing type display is provided with, for example, a photoconductor and a display element having bistability (e.g. cholesteric liquid crystal display element etc.).

### SUMMARY

According to an aspect of the invention, there is provided a writing device comprising: an irradiation unit that irradiates light to an optically writable display medium which displays an image responsive to irradiated light; a focusing unit that focuses light irradiated by the irradiation unit on the display medium; and a selector that causes the light irradiated by the irradiation unit to pass through or not to pass through the focusing unit for irradiation to the display medium.

### BRIEF DESCRIPTION OF THE DRAWINGS

Exemplary embodiments of the present invention will be described in detail based on the following figures, wherein:

FIG. 1 is a block diagram showing a configuration of a writing device;

FIG. 2 shows a configuration of a writing unit;

FIGS. 3A and 3B exemplify states where a position of a reflection component is switched;

FIG. 4 shows a configuration of a cross section of a display medium; and

FIGS. 5A and 5B show a modified example of the writing unit.

### DETAILED DESCRIPTION

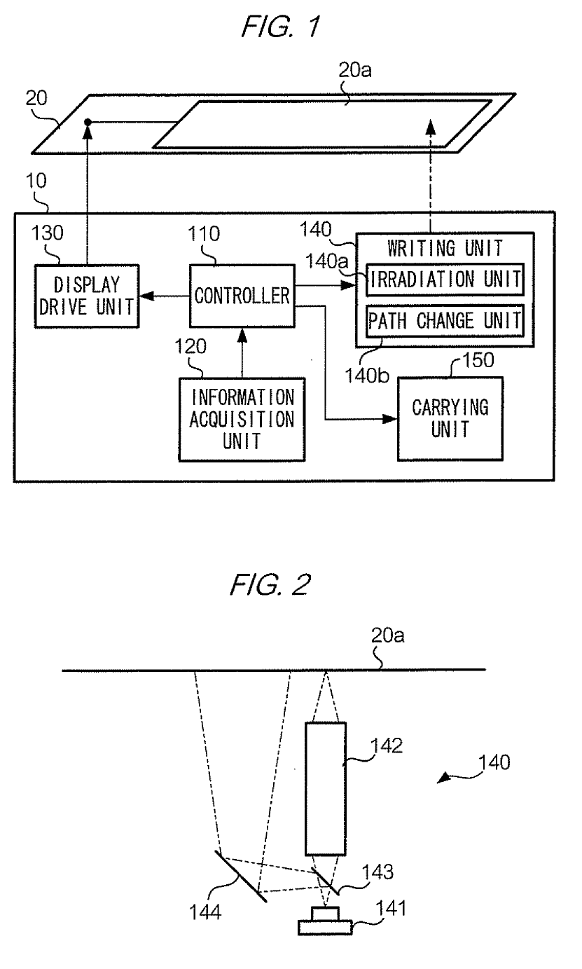

FIG. 1 is a block diagram that shows a configuration of a writing device according to an exemplary embodiment of the present invention. A writing device 10 shown in FIG. 1 is a writing device that writes information by irradiating light to a display medium 20 and is provided with a controller 110, an information acquisition unit 120, a display drive unit 130, a writing unit 140 and a carrying unit 150. The writing device 10 supports or holds the display medium 20 in a fixed state and goes into a state where writing can be performed through conduction with the display medium 20. Note that according to the present exemplary embodiment, the display medium 20 is provided with a rectangular recording surface 20a that includes at least an optical writing type display, however, the shape of the recording surface is not limited to a rectangular shape. Hereinafter, it is assumed that the short side direction of the recording surface 20a is used as the main scanning direction of the writing device 10, and the long side direction of the recording surface 20a is used as the sub-scanning direction of the writing device 10.

The controller 110 is provided with a computing device such as a CPU (Central Processing Unit) and controls operation of the writing device 10. The controller 110 supplies signals that define operation of the display drive unit 130, the writing unit 140 and the carrying unit 150 to these units according to information acquired from the information acquisition unit 120. The information acquisition unit 120 acquires display data that shows information to be displayed. The information acquisition unit 120 may acquire display data from recording media such as what is known as a memory card or may acquire display data via wired or wireless communication systems. Note that information that is represented by display data is information such as characters or images. Moreover, the information acquisition unit 120 may acquire information representing instructions from a user (start of writing etc.) as necessary in addition to display data.

The display drive unit 130 supplies necessary voltage for writing information to the display medium 20. The display drive unit 130 is provided with a direct current voltage generating circuit and terminals conducting with the display medium 20. Moreover, the display drive unit 130 may supply different voltage polarity when information is written and when information is erased. This is for suppressing what is known as burn-in occurring on the display medium 20.

The writing unit 140 is provided with a light source that irradiates light for writing information. The writing unit 140 in the present exemplary embodiment irradiates linear light or band-shaped light parallel to the main scanning direction. Note that when classified according to functions, the writing unit 140 can be classified into an irradiation unit 140a that has a function of irradiating light and a path change unit 140b that has a function of changing a path of irradiated light. The carrying unit 150 shifts a position of the display medium 20 where light is irradiated to the sub-scanning direction. Although the carrying unit 150 in the present exemplary embodiment shifts a position of irradiating light by carrying the light source, the carrying unit 150 may shift a position where light is irradiated (position where light is irradiated on the surface of the display medium 20) by carrying the display medium 20.

FIG. 2 shows a configuration of the writing unit 140. Specifically, the configuration of the writing unit 140 is shown in the figure, assuming that the direction perpendicular to the plane of the page is the main scanning direction. That is, the writing unit 140 has components shown in FIG. 2 that are confined to be substantially the same length as that of the short side of the recording surface 20a. The writing unit 140 is provided with a light emitting component 141, a focusing component 142 and reflection components 143 and 144. The light emitting component 141 is a light source such as an LED (Light Emitting Diode) chip. A LED chip includes plural LEDs disposed in a row manner on a substrate. The size of the LED chip is, for example, approximately 40 μm, depending on resolution of information written on the display medium 20. Note that the light source used as the light emitting component 141 may be not only an LED but also other light emitting elements.

The focusing component 142 is a component that focuses light irradiated by the light emitting component 141 on the recording surface 20a of the display medium 20. The focusing component 142 in the present exemplary embodiment has refractive index distribution type lenses disposed in a row manner, and the length of the focusing component 142 (size in the direction in which light passes) is approximately 5 mm, and its width in the sub-scanning direction is approximately 3 mm. Furthermore, the distance between the light emitting component 141 and the focusing component 142 is approximately 2 mm, and the distance between the focusing component 142 and the recording surface 20a of the display medium 20 is approximately 2 mm. That is, in the present exemplary embodiment, the distance between the light emitting component 141 and the recording surface 20a of the display medium 20 is approximately 9 mm. Thus, the ratio of the distance between the light emitting component 141 and the recording surface 20a of the display medium 20 to the width of the focusing component 142 in the sub-scanning direction is approximately 3 to 1.

The reflection component 143 is a component that reflects light irradiated by the light emitting component 141 onto the reflection component 144 at a position along a path from the light emitting component 141 to the focusing component 142. Note that the reflection component 143 may have a larger reflecting surface when disposed nearer to the focusing component 142. The reflection component 144 is a component that re-reflects light reflected by the reflection component 143 and irradiates the light on the recording surface 20a of the display medium 20. The reflection components 143 and 144 can be made of any materials as long as such reflection is achieved. Note that the reflection component 143 is configured to be switched by a drive unit such as a motor that is not shown from a state where a light path from the light emitting component 141 to the focusing component 142 is interrupted to a state where it is not interrupted. Such a drive unit is included in the path change unit 140b described above.

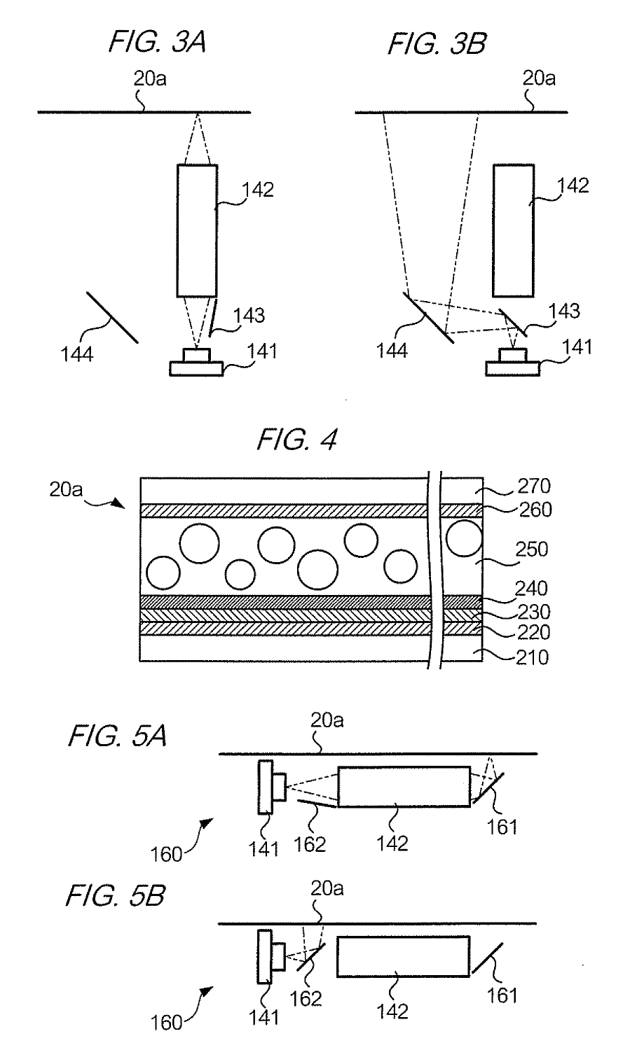

FIGS. 3A and 3B exemplify states where a position of the reflection component 143 is switched. As shown in FIGS. 3A and 3B, the reflection component 143 is switched using its one end point as an axis from the position shown in FIG. 3A to the position shown in FIG. 3B (or in reverse). When information is written, that is, when light is caused to pass through the focusing component 142, the reflection component 143 is in the position shown in FIG. 3A. However, when information is erased, that is, when light is not caused to pass through the focusing component 142, the reflection component 143 is in the position shown in FIG. 3B.

Note that states where a position of the reflection component 143 is switched may be made not only by rotating as the example shown in FIGS. 3A and 3B but also by, for example, shifting the entire reflection component 143 so as to switch between a state with reflection and without reflection.

FIG. 4 shows a configuration of the recording surface 20a of the display medium 20. The display medium 20 has film substrates 210 and 270, transparent electrodes 220 and 260, a photoconductive layer 230, a colored layer 240 and a display element layer 250 on the recording surface 20a. Note that the optical writing type display in the present exemplary embodiment is a display that displays monochromically. The film substrates 210 and 270 are layers provided to protect the recording surface 20a of the display medium 20 and are made of PET (polyethylene terephthalate) etc. The film substrate 210 is on the surface of the side to which light is irradiated, and the film substrate 270 is on the surface of the side from which a user views written information. The transparent electrodes 220 and 260 are layers that are composed, for example, of ITO (indium tin oxide), and each layer conducts with a terminal of the display drive unit 130. Thus, when the display drive unit 130 applies a voltage, a potential difference is generated between the transparent electrode 220 and the transparent electrode 260. The photoconductive layer 230 is a layer made up of an electrical conductor (i.e. photoconductor) exhibiting different electrical conductivity depending on a quantity of irradiated light. As the photoconductive layer 230, for example, an organic photoconductor can be used.

The colored layer 240, which is a layer visible when the display element layer 250 lets light through, has a predetermined color (black in the present exemplary embodiment). The display element layer 250 contains display elements exhibiting different light reflection states depending on the applied voltage. The display element layer 250 of the present exemplary embodiment is obtained by dispersing microencapsulated cholesteric liquid crystal display elements in a binder resin. The alignment of the cholesteric liquid crystal display elements may be a planar alignment or a focal-conic alignment. In case of a planar alignment, the cholesteric liquid crystal display elements reflect light (via Bragg reflection) to exhibit a predetermined color (white in the present exemplary embodiment) and, in case of a focal-conic alignment, transmit light to reveal the color of the colored layer 240.

The configurations of the writing device 10 and the display medium 20 in the present exemplary embodiment are as described above. With such configurations, when holding the display medium 20 and in a state where information can be written, the writing device 10 performs an operation to write information. Note that information writing may be started by instructions from a user. The operation for the writing device 10 to perform writing, i.e., the operation for the writing device 10 to irradiate light, can be divided into two kinds of modes such as a reset mode and a writing mode. The controller 110 of the writing device 10 controls the display drive unit 130, the writing unit 140 and the carrying unit 150 according to these modes.

The writing device 10 operates first in the reset mode and then in the writing mode. In the reset mode, the controller 110, preventing light from being focused on the focusing component 142, causes light to be irradiated to the photoconductive layer 230 of the display medium 20, and shifts a position for light to be irradiated from one end of the long side of the recording surface 20a to the other end. For example, the controller 110 prevents light from being irradiated to the focusing component 142 by positioning the reflection component 143 as shown in FIG. 3B. At this time, the controller 110 adjusts the quantity of light irradiated by the light emitting component 141 and/or the carrying speed of the carrying unit 150 in order to make light irradiated to the photoconductive layer 230 near to an equal quantity of light. Accordingly, by irradiating light uniformly on the recording surface 20a, information written beforehand in the display medium 20 is erased, and the entire recording surface 20a is caused to have an even tone (white in the present exemplary embodiment). Note that light irradiated in the reset mode should be uniformly irradiated, however, it may not be irradiated completely uniformly to an extent that display is not greatly influenced.

When the reset mode is switched to the writing mode, the controller 110 switches a state where light is irradiated. For example, the controller 110 switches the position of the reflection component 143 from the position shown in FIG. 3B to that in FIG. 3A. As a result, light is irradiated to the focusing component 142 because there is no obstacle to the passage of light. Light irradiated at this time is not uniformly irradiated as in the reset mode, but irradiated according to the display data. Consequently, the display medium 20 is caused to have tone in accordance with light irradiated to each position (pixel) of the recording surface 20a. Note that, when switching modes, the controller 110 may supply a signal for switching the polarity of supplied voltage to the display drive unit 130 or may supply a signal for switching the carrying speed to the carrying unit 150.

As described above, according to the writing device 10 in the present exemplary embodiment, without using a light source other than the light emitting component 141, light that is not focused by the focusing component 142 is irradiated to the display medium 20 in the reset mode, and light that is focused by the focusing component 142 is irradiated to the display medium 20 in the writing mode.

Light irradiated to the photoconductive layer 230 is irradiated to a larger area at one time when not passing through the focusing component 142 (reset mode), compared to when passing through the focusing component 142 (writing mode). In addition, light irradiated to the photoconductive layer 230 does not incur a loss caused by transmittance of the focusing component 142 when not passing through the focusing component 142. Generally, a quantity of light that does not pass through the focusing component 142 is larger than light that passes through the focusing component 142 in accordance with light transmittance of the focusing component 142. For example, because the transmittance of a refractive index distribution type lens is approximately 2 to 4%, if a refractive index distribution type lens is used as the focusing component 142, a quantity of light when passing and not passing through the focusing component 142 differs by approximately 25 to 50 times.

Generally, when kept in an environment with high temperature, even if driven under the same drive condition as that when kept at lower temperature, the display medium 20 tends to have different reflectance from that when kept at low temperature. That is, when the display medium 20 is kept at high temperature, there are cases where the display medium 20 is unable to erase information completely in the reset mode. Furthermore, when kept in an environment with high temperature, unless information is erased with a larger quantity of light, the display medium 20 is unable to obtain the same reflectance as when kept in an environment with low temperature. Thus, if information needs to be erased completely in the display medium 20 used in various environments, irradiation needs to be performed with as large a quantity of light as possible in the reset mode.

According to the writing device 10 in the present exemplary embodiment, when information is erased, irradiation is performed with a larger quantity of light than when irradiation of light to the display medium 20 is performed in the same state as when information is written. Consequently, compared to such a case, information in the display medium 20 kept in an environment with higher temperature can be erased. Moreover, according to the writing device 10 in the present exemplary embodiment, compared to a case where light is irradiated to the display medium 20 in the same state as when information is written, the reflectance of the recording surface 20a of the display medium 20 is higher after information is erased.

### MODIFIED EXAMPLES

The exemplary embodiment described above is an example of the present invention. Modified examples described below, for example, are applicable to the present invention. Note that the exemplary embodiment described above and the modified examples below may be combined as necessary.

### (1) Modified Example 1

FIGS. 5A and 5B show a modified example of the writing unit 140 described above. A writing unit 160 in the present example is provided with reflection components 161 and 162 instead of the reflection components 143 and 144 of the writing unit 140, and the direction of light irradiated by the light emitting component 141 is made parallel to the recording surface 20a of the display medium 20. Additionally, with this, the direction of light passing through the focusing component 142 is also made parallel to the recording surface 20a of the display medium 20, and light irradiated by the light emitting component 141 passes through from a near side (side near to the light emitting component 141) to a far side (side near to the reflection component 161). The reflection component 161 reflects light focused by the focusing component 142 onto the recording surface 20a. That is, the reflection component 161 functions as a component to focus light on the recording surface 20a in cooperation with the focusing component 142. The reflection component 162 reflects light irradiated by the light emitting component 141 onto the recording surface 20a at a position along a light path from the light emitting component 141 to the focusing component 142. The reflection component 162 similar to the reflection component 143 of the writing unit 140 is configured to be switched by a drive unit that is not shown from a state where a light path from the light emitting component 141 to the focusing component 142 is interrupted (FIG. 5B) to a state where that is not interrupted (FIG. 5A).

With the configuration of the present example, compared to the configuration of the exemplary embodiment described above (FIG. 2), a light path is shorter in the direction of the thickness of the writing unit 140 (size in the direction perpendicular to the recording surface 20a of the display medium 20). Particularly, when the length of the focusing component 142 and/or focal length is/are longer than that in the exemplary embodiment, the proportion to shorten the path in the thickness direction is larger.

### (2) Modified Example 2

According to an aspect of the invention, switching a case where light is focused on a focusing component to a case where it is not focused may be preformed not only by providing a reflection component between an irradiation component and the focusing component (exemplary embodiment) but also by shifting the focusing component using a drive unit. When the focusing component is shifted, a path of light irradiated by the irradiation component does not change when light is focused on the focusing component and when is not focused (although whether light passes through the focusing component or not is a different aspect).

### (3) Modified Example 3

According to an aspect of the invention, there is a case where an operation of erasing information and an operation of writing information do not need to be performed continuously. For example, when writing is preformed on a display medium where information is not written yet (i.e. blank page), the operation of erasing information does not need to be performed before the operation of writing information. Thus, a writing device according to the present invention may be configured to perform switching, for example, between a mode of performing the operation of erasing information, a mode of performing the operation of writing information and a mode of performing the operation of erasing information and the operation of writing information continuously in accordance with an operation from a user.

### (4) Modified Example 4

According to an aspect of the invention, an optical writing type display may perform not only monochrome display but also color display. Furthermore, not only a cholesteric liquid crystal display element but other display elements may be used for the optical writing type display.

### (5) Modified Example 5

A writing device according to the present invention can be taken as the entire writing device 10 including the display drive unit 130 and the carrying unit 150 that are described above, however can also be taken as what is known as a single recording head (writing unit 140). When the entire writing device 10 is taken as the writing device according to the present invention, a switching unit can be considered to be operated with the cooperation of the controller 110 and the writing unit 140. Moreover, when the writing unit 140 is taken as the writing device according to the present invention, switching operation is performed by the reflection component 143 (or the reflection component 162) and a drive unit that shifts the reflection component. In addition, the writing device according to the present invention may be configured together with an optical writing type display, for example, like a combination of the writing device 10 and the display medium 20.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A writing device comprising:
an irradiation unit that irradiates light to an optically writable display medium which displays an image responsive to irradiated light;
a focusing unit that focuses light irradiated by the irradiation unit on the display medium; and
a selector that causes the light irradiated by the irradiation unit to pass through or not to pass through the focusing unit for irradiation to the display medium.

2. The writing device according to claim 1, wherein the selector comprises a selecting element, provided at a position along a light path from the irradiation unit to the focusing unit, that affects the passage of light to the focusing unit.

3. The writing device according to claim 2, wherein:
the irradiation unit irradiates light in a direction parallel to a surface of the display medium;
the focusing unit comprises: a focusing element that focuses light irradiated by the irradiation unit; and a first reflector that reflects light passing through the focusing unit to irradiate the light on the display medium; and
the selecting element comprises a second reflector that reflects light irradiated by the irradiation unit, provided at a position along a light path from the irradiation unit to the focusing element.

4. The writing device according to claim 1, wherein light that passes through the focusing unit is used for writing an image on the display medium and light that does not pass though the focusing unit is used for deleting an image on the display medium.
